(19) United States
(12) Patent Application Publication
(10) Pub. No.: US 2004/0049956 A1
(43) Pub. Date: Mar. 18, 2004

(54) System for personalized collection of baby teeth

(76) Inventor: Xiang-Long Li, Briarcliff Manor, NY (US)

Correspondence Address: Keith D. Nowak, DICKSTEIN SHAPIRO MORIN & OSHINSKY LLP, 1177 Avenue of the Americas, 41st Floor, New York, NY, 10036-2714, US

(21) Appl. No.: 10/244,485

(22) Filed: Sep. 16, 2002

(51) Int. Cl. G09F 1/00

(52) U.S. Cl. 40/124.06

(57) ABSTRACT

The above and related objects are achieved by providing, in one embodiment, a collection kit having a dental chart that can be personalized for a child. The dental chart provides spaces for easy recording of information about the child at various stages of development, in particular information at the times when baby tooth are lost. The chart may include can include corresponding clear plastic pockets for the safekeeping and display of the teeth. Toys for receiving and holding the teeth may be incorporated into the kit.

### BACKGROUND OF THE INVENTION

Childhood is a time in our lives that many of us (and our parents) remember fondly. It is a common practice for many parents, wishing to create a keepsake of their child's early years, to collect the primary teeth (or “baby teeth” as it is commonly called) that their children loses. This is frequently done with the aid of the fiction of the “tooth fairy.” The parent can ensure that a child doesn't misplace or throw away a tooth that has newly come off by enticing them with the promise of a small gift from the “tooth fairy.” That way, the child will know to keep the loose tooth safe until bedtime, at which time the “tooth fairy” comes and collects the loose tooth from underneath their pillows. There are, of course, other ways for a parent to collect the baby teeth, and the parent can involve the child directly in the collecting process.

Once the parent has painstakingly retrieved the baby tooth, however, it is frequently just dumped into a box for safekeeping. In fact, there are ornamental boxes sold for just that purpose. Over the course of a few years, these amass into a collection of loose teeth rattling around in a box. A wealth of information would be lost with the passage of time: what were the circumstances involved in losing a particular tooth? What date was the tooth lost? Where was the child? What was he/she doing? What did he/she look like with the missing tooth? Was the tooth healthy or decayed? Did the child learn important oral hygiene lessons at that point in his or her development?

### OBJECTS OF THE INVENTION

It is the above and related objects of this invention to address the above as well as related deficiencies in what is commonly practiced.

More specifically, it is the principal object of this invention to provide a collection kit that includes a dental chart that can be personalized for the recording of data on the child and the circumstances of how each tooth was lost.

A further object of the invention is to promote and encourage good dental hygiene habits for the growing child, as a healthy set of primary teeth without cavities makes for a handsome display that the parent and child can be proud of.

It is another object of this invention to provide a kit that includes dental hygiene instructions and information written by dental healthcare professionals that is educational to both the parent and child. It is a related object of this invention to provide easy means to record the dental development of a child, and to provide an reminder for the scheduling of check-ups.

It is another object of this invention to provide an easy way to collect and permanently display baby teeth.

It is another object of this invention to provide collectible keepsakes in the form of childhood toys in order to proudly display the collection of teeth.

It is still yet another object of this invention to provide a kit that eases the collection process of baby teeth, as it takes a number of years for a child to completely replace his or her baby teeth.

### SUMMARY OF THE INVENTION

The above and related objects are achieved by providing, in one embodiment, a collection kit having a dental chart that can be personalized for a child. The dental chart provides spaces for easy recording of information about the child at various stages of development, in particular information at the times when baby tooth are lost. The chart may include can include corresponding clear plastic pockets for the safekeeping and display of the teeth.

More specifically, the chart includes, by way of example, one or more spaces for recording the circumstances surrounding the loss of each tooth. Was the tooth lost naturally? Removed at the dentist? Knocked loose in a mishap? All these could be easily recorded in a space-efficient manner on the chart.

Spaces can be provided for affixing photographs of the child at the time of the loss of a tooth (perhaps smiling broadly to show off the new gap in his teeth).

Provided on the chart is information written by dental care professionals about important milestones in a child's dental development. A parent can use this check-list of information to chart the child's dental development and to schedule checkups.

In another of the preferred embodiments of this invention, teeth holders in the shape of childhood toys accompany the dental chart. These holders can be in the form of a train set, a set of racecars, action figures or dolls, or even plush toys. They evoke a sense of the whimsy associated with early childhood, while acting as handsome showpieces to proudly display the “once-in-a-lifetime” collection.

In a still further embodiment of the invention, the kit can have a software component that is run from a personal computer. Parents can easily record the information discussed above in a software dental chart.

### BRIEF DESCRIPTION OF THE DRAWINGS

FIG. 1 is a dental chart of the collecting kit of this invention.

FIG. 1 a shows a sheet of stickers for use with the dental chart.

FIG. 2 is a toy train set for the display of teeth.

FIG. 3 is a racecar for the display of teeth.

FIG. 4 is toy aircraft for the display of teeth.

FIG. 5 is a toy with a face for the display of teeth.

FIG. 6..is a representative toy figure for the display of teeth.

FIG. 7 is a chess piece for the display of teeth.

### DETAILED DESCRIPTION OF THE INVENTION INCLUDING PREFERRED EMBODIMENTS

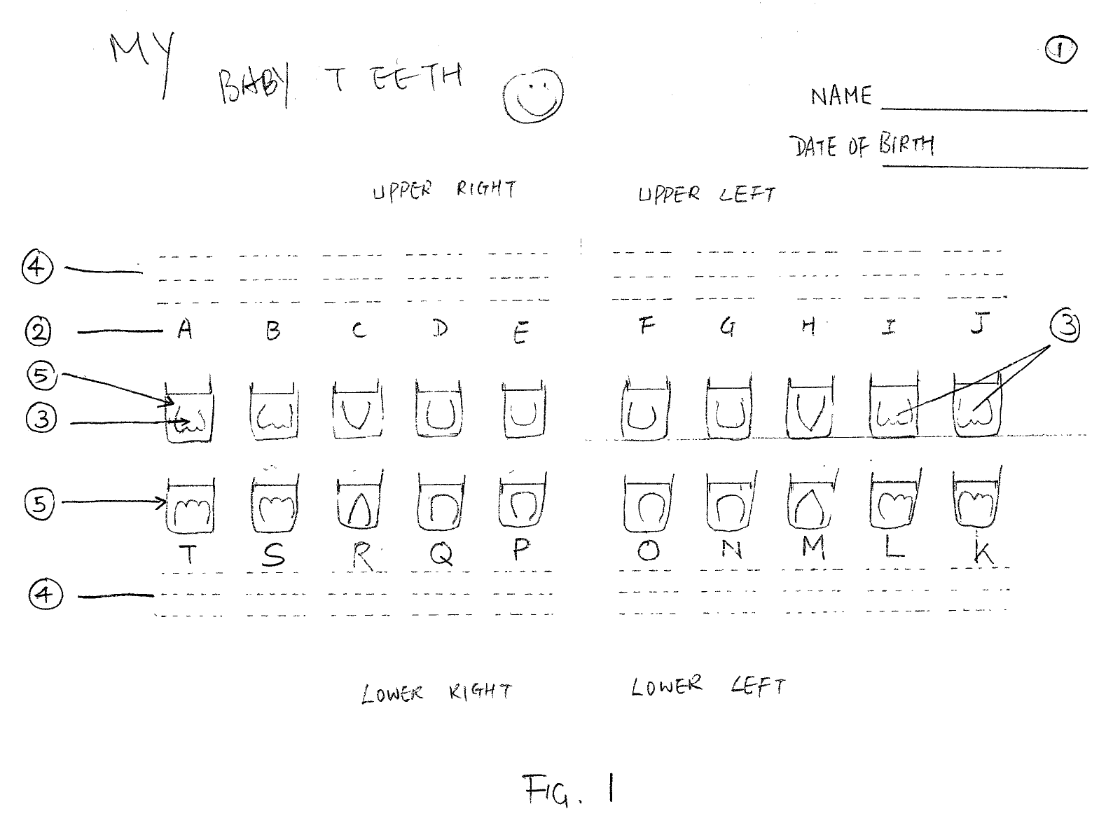

The preferred embodiment of this invention includes a dental chart as shown in FIG. 1. The chart is preferably of a large enough size to hold the twenty (20) baby tooth in a spacious manner, with enough space left over for the recording of information.

At a prominent place in the chart, a space is available for filling in the child's name and birth date 1. The baby teeth are designated by letters A through T from the upper right side to the lower right side, and from the lower left side to the lower right side 2. Above and below the designation are graphical representations of the teeth 3, laid out as each tooth would be located in the mouth. The graphical representations can be accompanied by the names of the teeth (molar, canine, etc). Spaces for the recording of information regarding each tooth are located above and below the designations 4. Pertinent information to be recorded includes i) the date the particular tooth came off; ii) the place where the tooth came off; iii) the manner which the tooth came off: by extraction, naturally, or by accident. Alternatively, checkboxes can be provided for easy input of this information. Similarly, a sheet of stickers as shown in FIG. 1a can be included. The sheet of stickers, 6, can be pre-printed with individual peel-off stickers 7 bearing symbols or legends for how a tooth was lost. These symbols should include a) a healthy tooth, b) decayed tooth c) extraction and d) accident. There should be a set a)-d) of stickers for each tooth A-T.

The kit may include a sanitary solution, either coming in the form of a bottled liquid or water-soluble tablets, for the purpose of cleaning each tooth.

In a preferred embodiment, tooth collection pockets made of clear plastic are situated over the graphical representations of the teeth 5. When a new tooth becomes available, it becomes a simple matter for the user to insert it into the proper pocket by matching it with the graphical representation. After the tooth is inserted, it should cover the graphical representation behind it, so that the chart doesn't become too crowded with too many elements.

The kit can include a software component which can generate, on a personal computer, the dental chart as described above. Having a software component results in a neater, more presentable chart that can be made to look like a certificate or diploma. Graphic images, including photos of the child, can easily be incorporated into the chart.

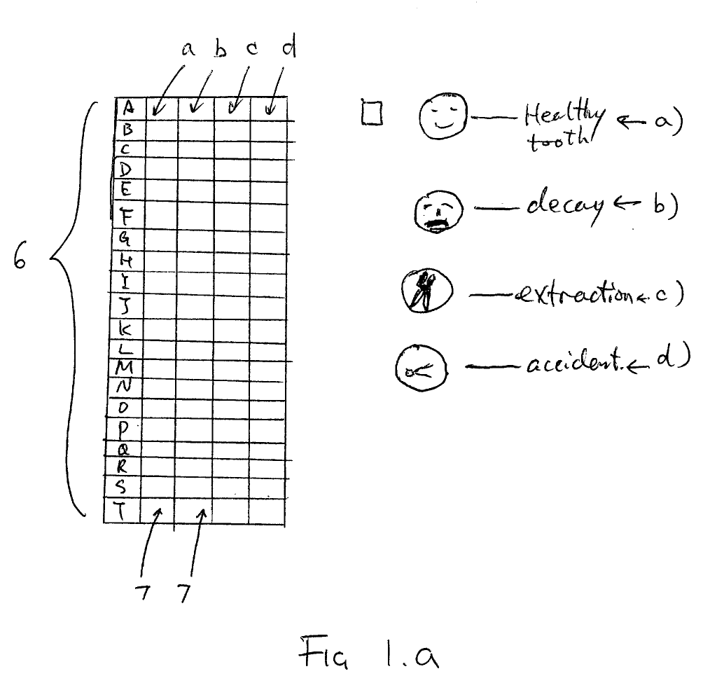

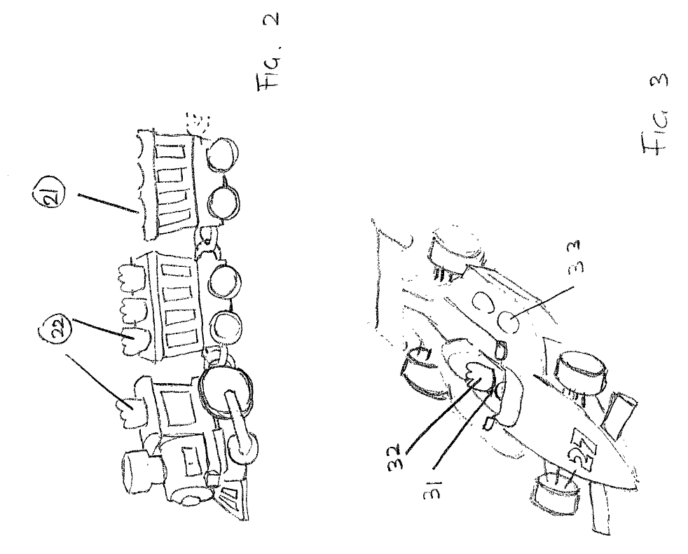

FIG. 2 illustrates a representative toy vehicle, a toy train set, with indented portion(s) on each car 21 for receiving and holding the baby teeth 22. Similarly, FIG. 3 shows a representative racecar with an indented portions on each car 31 for receiving and holding the baby teeth 32. A tooth can go into the space where the driver's helmet would be. FIG. 4 shows a toy airplane, with indentations on its wings 41 to hold and receive the teeth 42. The left-side wing would carry the left-side upper and lower teeth on the leading and trailing edges, and the right-side wing would do the same for right-side teeth. In another embodiment (not shown) a fleet of small aircraft and an aircraft carrier could be used, with each small airplane holding just one (or more) teeth. In principle, any toy vehicle could be used with the invention, following the examples set forth above.

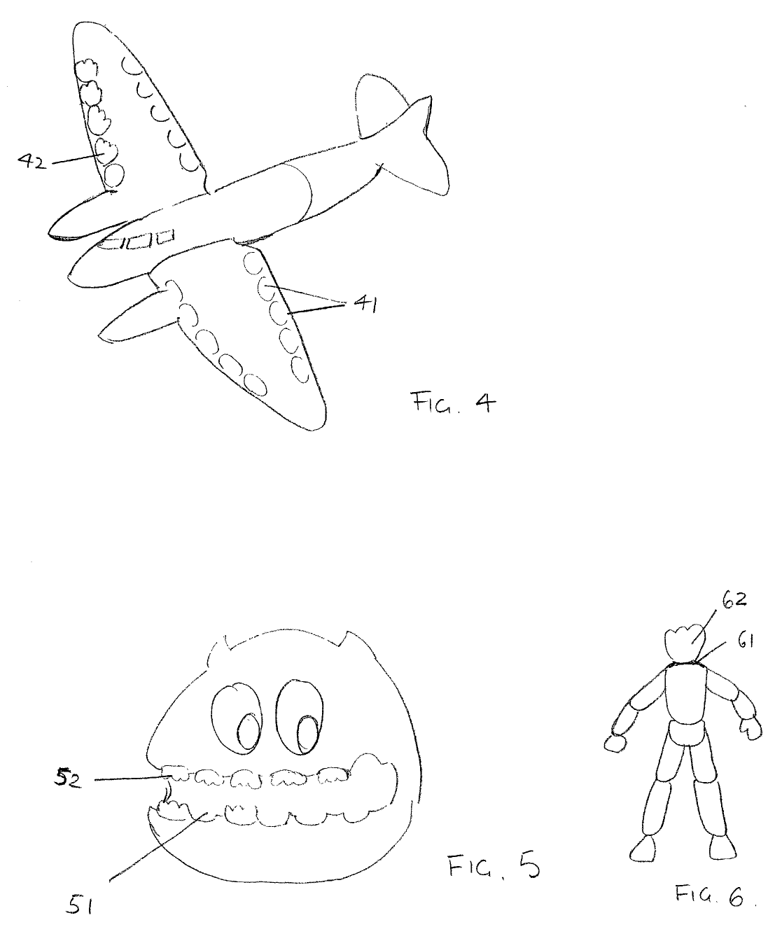

FIG. 5 illustrates a toy body form incorporating a jaw in accordance with the kit of this invention. The toy's face, with a whimsical representation of the human jaw, has the same indentations 51 for receiving and holding the teeth 52. Each tooth can conveniently be held in the same order/position as in a human mouth. The jaw should able to open and close, at least to a degree to which the teeth can be easily inserted. A variety of toy figures, including dolls, action figures, plush toys, stuffed animals and even masks can be made in accordance with the principles set forth here.

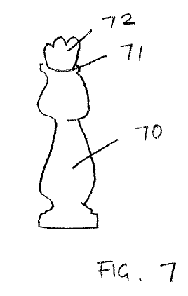

FIG. 6 shows a representative toy figure, with an indentation in the neck/shoulder region 61 for receiving a tooth 62. Once the tooth is inserted, it becomes a representation of a head for the figure. Similar to the toy figure shown in FIG. 7, a chess set can be made in which each chess piece 70 has an indentation 71 that holds one tooth 72 . A variety of toy figures, including dolls, action figures, robot toys, and toy soldiers can be made in accordance with the principles set forth here.

In addition, other applications of this invention shall become apparent as it is adapted to diverse environments and uses. Thus, it is neither the neither the purpose nor the intent of this disclosure to delineate the scope of this invention, which is set forth in the following claims.

What is claimed is:

1. A system for the collection and display of primary teeth, comprising:
a dental chart; said dental chart comprising graphic representations of each tooth, pockets for the holding of primary teeth, spaces for recording of information about the teeth and the donor child;
and dental hygiene information on a child's dental development;
said pockets being made of a clear material in order to display the teeth within.

2. The system of claim 1 wherein the dental chart is generated by software running on a computer, and the recording of information about the teeth and the donor child is input by a user on said computer.

3. The system of claim 2, wherein said pockets for the holding of primary teeth is affixed to the dental chart by the user after the dental chart has been printed out.

4. A system for the collection and display of primary teeth, comprising: one or more toys with receptacles to receive and hold primary teeth.

5. The system of claim 4, wherein the toy is a vehicle.

6. The system of claim 5, wherein the vehicle is a racecar.

7. The system of claim 5, wherein the vehicle is a train.

8. The system of claim 5, wherein the vehicle is an airplane.

9. The system of claim 8, wherein the airplane has receptacles for receiving and holding primary teeth on the wings.

10. The system of claim 4, wherein the toy is a chess set and each chess piece holds one primary tooth.

11. The system of claim 4, wherein the toy has a face with a mouth that can be opened and closed, said mouth having receptacles to receive and hold primary teeth.

12. The system of claim 11, wherein the toy is a plush toy.

13. The system of claim 11, wherein the toy is a mask.

14. The system of claim 4, wherein the toy is a figure that has a receptacle to receive and hold a tooth, said tooth taking the place of the figure's head.

15. A system for the collection and display of primary teeth according to claim 1 or 2, further comprising:
the system according to claim 4.

16. The system according to claim 1, further comprising a solution for the cleaning and preservation of primary teeth.

17. The system according to claim 16, wherein the solution is supplied in bottled form.

18. The system according to claim 16, wherein the solution is supplied in the form of dissolvable tablets.

19. A system for the collection and display of primary teeth according to claim 1 or further comprising:
at least one sheet of pre-printed stickers, said stickers having printed thereon symbols denoting information regarding a tooth.
